(19) United States
(12) Patent Application Publication
(10) Pub. No.: US 2014/0057034 A1
(43) Pub. Date: Feb. 27, 2014

(54) APPARATUS AND METHOD FOR MAKING A BEVERAGE

(71) Applicant: YUNG HUA WANG, New Taipei (TW)

(72) Inventor: YUNG HUA WANG, New Taipei (TW)

(21) Appl. No.: 13/969,552

(22) Filed: Aug. 17, 2013

(30) Foreign Application Priority Data
Aug. 22, 2012 (TW) 101216099
Feb. 1, 2013 (TW) 102104002

(51) Int. Cl. B01F 3/04

(52) U.S. Cl. CPC B01F 3/04787
USPC 426/477; 261/119.1; 261/72.1

(57) ABSTRACT

Apparatus for making a beverage is described. The apparatus comprises a carbonator and an inhibitor. The carbonator is for carbonating a liquid. The liquid is foamed to have bubbles. The inhibitor may be penetrated with the carbonator. The inhibitor is for inhibiting the foaming of the liquid.

### BACKGROUND OF THE INVENTION

(1) Field of Invention

This invention relates generally to a method of making a beverage, and more particularly to apparatus for making a beverage.

(2) Description of Related Art

Carbonated beverages mean that the carbon dioxide gas dissolved in beverages. Carbonated beverages have types such as soda, sour, sawa, etc. In the market of carbonated beverages, the most common may be a non-alcoholic soft drink also known as soda, soda water or sparkling water.

When a vessel of a carbonate beverage is opened, or the carbonate beverage is drunk, there will be carbon dioxide bubbles. This may also be the reason why carbonate beverage is children's most favorite beverages.

In a traditional carbonated beverage manufacturing process, water, a base of carbonated beverages, is positioned in a high pressure and sealable vessel.

High pressure carbon dioxide is transferred into the vessel with a closed state, to carbonate the water as tasteless carbonated water. After mixing specific flavor syrup or mixture orange flavored syrups, flavoring agents and pigments, a specific taste of carbonated drinks, such as soda with orange taste, is produced. Accordingly, the carbonated drinks have a composition of water, syrup and chemicals of the flavoring agents and pigments.

What amazing is that the orange soda contains no natural orange ingredient. Its flavors and colors are formed by the chemicals.

The traditional carbonated beverage manufacturing process is still applied in the recent inventions, For example, the invention “non caloric frozen carbonated beverages” (Taiwan Patent No. 1265009, also published as U.S. Pat. No. 8,465,786) and the invention “carbonated drink having high gas pressure” (Taiwan Patent Application No. 09813294, also published as US 2001/0217431), add additional chemicals to increase the taste or flavor.

Nowadays, the values of health and food nutrition are emphasized, it is doubt that a carbonated drink with so many chemical seasoning pigments and so high glucose is suitable for children to drink.

Therefore, there is a need to study and improve the issue of carbonated beverages.

### SUMMARY

In one aspect of the present invention, apparatus for making a beverage is provided. The apparatus comprises a carbonator and an inhibitor. The carbonator may be for carbonating a liquid. The liquid may be foamed to have a plurality of bubbles. The inhibitor may be penetrated with the carbonator. The inhibitor may be for inhibiting the foaming of the liquid.

In another aspect of the present invention, a method for making a beverage is provided. In this method, a liquid is carbonated, whereby the liquid is foamed to have a plurality of bubbles during the carbonation. The foaming of the liquid is inhibited by a filter plate having a plurality of voids.

### BRIEF DESCRIPTION OF THE DRAWINGS

FIG. 1 schematically illustrates a sectional view of a machine for making a carbonated beverage;

FIG. 2 schematically illustrates a sectional view of an output device and a machine for making a carbonated beverage;

FIG. 3 schematically illustrates a sectional view of a lid-type machine for making a carbonated beverage.

FIG. 4 schematically illustrates a process for making a carbonated beverage;

FIG. 5 schematically illustrates a process for making a carbonated beverage;

FIG. 6 schematically illustrates a sectional view of foam-inhibiting apparatus for making a carbonated beverage according to a second preferred embodiment;

FIG. 7 schematically illustrates a process for making a carbonated beverage by the form-inhibiting apparatus of FIG. 6;

FIG. 8 schematically illustrates a process for making a carbonated beverage by the foam-inhibiting apparatus;

FIG. 9 schematically illustrates a sectional view of foam-inhibiting apparatus for making a carbonated beverage, wherein the apparatus comprises a plurality of inhibitors, according to a third preferred embodiment;

FIG. 10 schematically illustrates a top view of an inhibitor;

FIG. 11 schematically illustrates a sectional view of foam-inhibiting apparatus for making a carbonated beverage, wherein the apparatus comprises a first through hole, according to a fourth preferred embodiment;

FIG. 12 schematically illustrates a sectional view of apparatus for making a carbonated beverage, wherein the apparatus comprises a grip, according to a fifth preferred embodiment;

FIG. 13 schematically illustrates a sectional view of applying the apparatus of FIG. 12;

FIG. 14 schematically illustrates a top view of an upper metal mesh and an lower metal mesh;

FIG. 15 schematically illustrates another sectional view of applying the apparatus of FIG. 12;

FIG. 16 schematically illustrates a sectional view of an inhibitor and voids thereof;

FIG. 17 schematically illustrates a sectional view of an inhibitor and voids thereof;

FIG. 18 schematically illustrates a sectional view of apparatus for making a carbonated beverage, according to a sixth preferred embodiment; and

FIG. 19 schematically illustrates a sectional view of apparatus for making a carbonated beverage, according to a seventh preferred embodiment.

### DETAILED DESCRIPTION OF THE INVENTION

One point of improvement is a method and apparatus of directly and effectively carbonating a variety of beverages other than water. The beverages are true or restore ingredients juice, tea, alcohol or other artificial modulated beverages which can be directly drunk. Such carbonated beverages are more natural and healthy choices for children who like drinking soda.

This invention enables drink industry to easily use the natural substrate to produce carbonated beverages. The industrial technology is enhanced so that the market is also expanded.

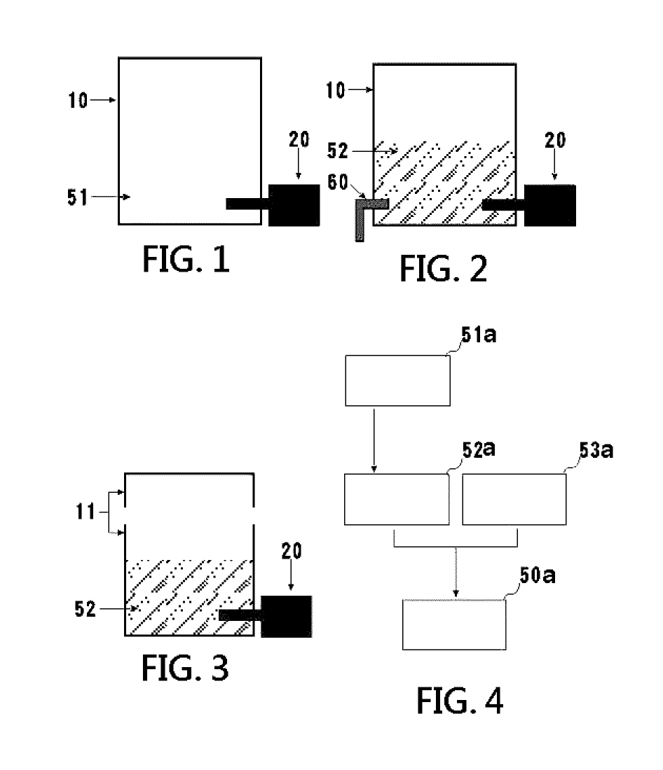

FIG. 1 schematically illustrates a sectional view of a machine for making a carbonated beverage.

FIG. 2 schematically illustrates a sectional view of an output device and a machine for making a carbonated beverage.

Referring to FIG. 1 and FIG. 2, in a carbonated beverage manufacturing process, water 51 is a substrate positioned into a high pressure and sealable vessel 10. In a closed state, high pressure carbon dioxide is transferred into water 51 in the vessel 10 to carbonate the water 51 in a high pressure environment, by an input device 20 of carbon dioxide. A lot of carbon dioxide is dissolved in water, so that the water 51 is carbonated to be a tasteless carbonated water 52 (FIG. 2). An output device 60 is then operated to output the carbonated water 52.

Alternatively, FIG. 3 schematically illustrates a sectional view of a lid-type machine for making a carbonated beverage. Referring FIG. 3, a lid can be lifted to open the lid-type vessel 11.

FIG. 4 schematically illustrates a process for making a carbonated beverage. Referring to FIG. 4, in step 51a, water is provided. In step 52a, the tasteless carbonated water is output from the vessel. In step 53a, specific flavor syrup or a mixture thereof is added into the water. In step 50a, a product of carbonated beverage with a specific taste is produced.

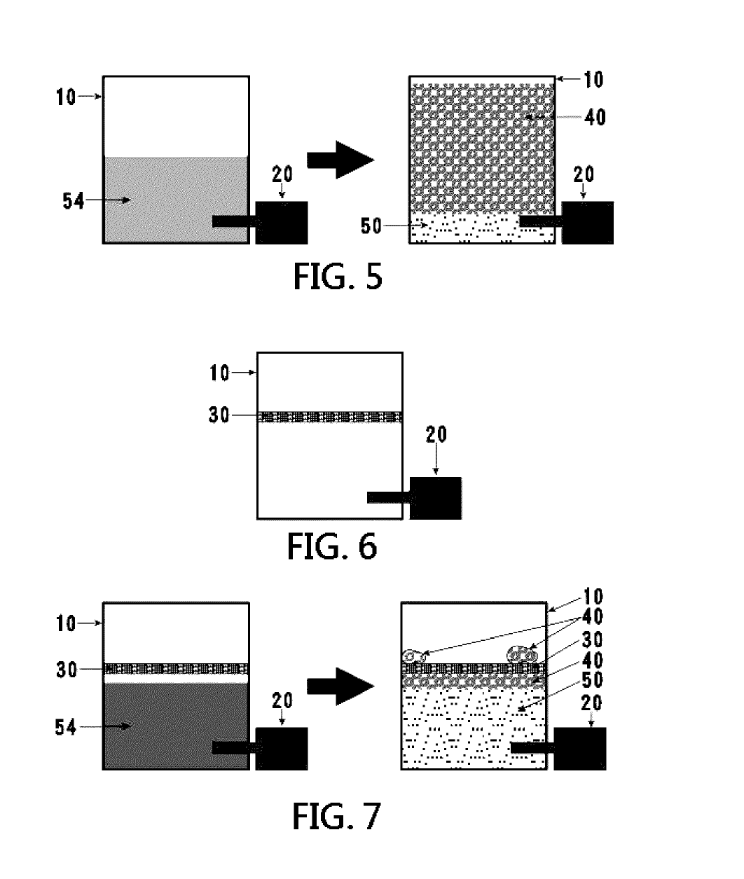

FIG. 5 schematically illustrates a process for making a carbonated beverage. Referring to FIG. 5, in this process for making a carbonated beverage, one of true or restore ingredients juice, tea, alcohol or other artificial modulated beverages which can be directly drunk serves as a substrate 54 for making a carbonated beverage 50. The substrate 54 is positioned in the vessel 10. In a closed state, high pressure carbon dioxide is transferred into substrate 54 in the vessel 10. As a result, a lot of bubbles 40, but only a small amount of liquid carbonated beverages 50 is produced.

In three periods of the process of FIG. 5, bubbles may be generated again and again.

First, the carbon dioxide is transferred into the vessel 10. Second, the high pressure and sealable vessel 10 is opened. Third, the carbonated beverage is poured to a mobile cup.

One reason why a lot of bubbles are generated in the process of FIG. 5 is that the substrate has thickness greater than water. On the other hand, the substrate also has ingredients more complex than water. The ingredients comprise a large number of suspended particles, namely, a large number of nuclei for formation of bubbles in the production of the carbonated beverages. The nuclei serve as nucleation sites for carbon dioxide.

Referring FIG. 5, the substrate 54 is positioned in the pressure and sealable vessel 10. Carbon dioxide is poured into the liquid 54, to carbonate the liquid 54, by a carbonator 20. During the carbonation, the liquid 54 is foamed to have a plurality of bubbles 40, by the induction of the nuclei.

More specifically, about 50% to 75% of the amount of the substrate 54 is transferred to be bubbles 40. Depending on the components of the substrate 54, only about 50% to 25% of the amount of the substrate 54 is still liquid after being carbonated. It takes about 10-40 minutes to eliminate the bubbles 40 by naturally standing the vessel 10. It is a time-consuming step in the process for making the carbonated beverage 50.

Referring to FIG. 5, when the vessel 10 is opened, or the carbonated beverage 50 is output by an output device, the pressure of the vessel 10 is suddenly reduced. Due to the reduction, dissolved carbon dioxide floats over the surface of the carbonated beverage 50. The floating carbon dioxide meets the nuclei, thereby generating a lot of bubbles 40 again. The bubbles 40 may even float out of the vessel 10, so that only about 50% to 25% of the amount of the carbonated beverage 50 leaves in the vessel 10.

The carbonated beverage 50 is then poured to a mobile cup. The force of pouring and the change of pressure again generate a lot of bubbles 40.

The bubbles are repeatedly generated as mentioned above. Therefore, only a very small amount of liquid carbonated beverage 50 may be made.

According to a first preferred embodiment of the invention, a method for making a beverage is described. In this method, a liquid is carbonated, whereby the liquid is foamed to have bubbles during the carbonation. When the carbonated liquid is moved, the carbonated liquid is also foamed to have bubbles. The first foaming and the second foaming can be both inhibited by an inhibitor. The inhibition is completed by, for example, breaking the bubbles. The bubbles are broken and then reduced to be liquid.

FIG. 6 schematically illustrates a sectional view of foam-inhibiting apparatus for making a carbonated beverage according to a second preferred embodiment.

FIG. 7 schematically illustrates a process for making a carbonated beverage by the form-inhibiting apparatus of FIG. 6.

Referring to FIG. 6 and FIG. 7, the apparatus may comprise a high pressure and sealable vessel 10, a carbonator 20 and an inhibitor 30. The carbonator 20, may be a carbon dioxide input device, is for carbonating a liquid 54 in the vessel 10. The liquid 54 is carbonated to be a carbonated beverage 50. When the carbon dioxide is induced by, for example, some specific nuclei of the liquid 50, the liquid 50 may be foamed to have a plurality of bubbles 40 during the carbonation.

The inhibitor 30 may be for inhibiting the foaming of the liquid 54. The foaming of the liquid may be inhibited by, for example, breaking the bubbles 40. The inhibitor 30 may be located in a position of the vessel 10 which may be passed through by the bubbles 40.

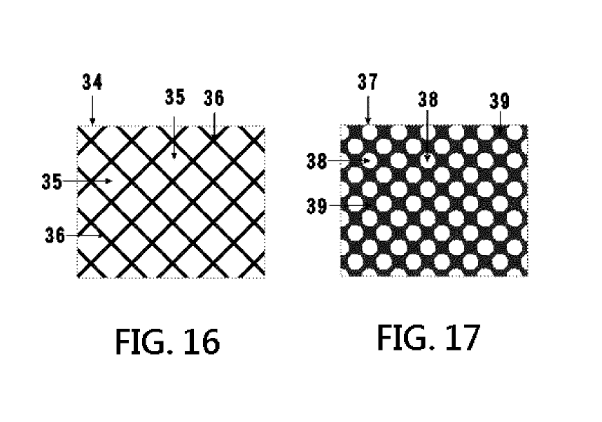

FIG. 16 schematically illustrates a sectional view of an inhibitor and voids thereof.

FIG. 17 schematically illustrates a sectional view of an inhibitor and voids thereof.

Referring to FIG. 16, the inhibitor 30 (FIG. 7) may be a mesh 34 of metal, plastic or other solid substance. The mesh 34 comprises voids 35. The neighboring voids 35 of the mesh 34 have a connector 36. The connector 36 is not limited, but can be proper to inhibit the foaming of the liquid 54 (FIG. 7), and proper to break the bubbles 40.

Referring to FIG. 17, the inhibitor 30 (FIG. 7) may be a filter plate 37 having voids 39. The neighboring voids 38 of the filter plate 37 have a connector 39. The connector 39 is not limited, but can be proper to inhibit the foaming of the liquid 54 (FIG. 7), and proper to break the bubbles 40.

Referring to FIG. 7, the inhibitor 30 may be a stainless steel mesh. Comparing to FIG. 5, most of the bubbles 40 is inhibited by the inhibitor 30 (FIG. 7). As shown in FIG. 7, only a few bubbles 40 leave between the inhibitor 30 and the liquid surface, or leave on the inhibitor 30.

Referring to FIG. 16 and FIG. 17, each of the voids 35 and 37 may be small than the bubbles 40, so that most of the bubbles 40 cannot pass through the inhibitor 30. A lot of bubbles 40 are broken by the connectors 36 or 39 and are reduced to be liquid.

Referring to FIG. 7, after the liquid 54 is carbonated by being filled with the carbon dioxide through the carbonator 20, only a quite few bubbles 40 may be rushed onto the inhibitor 30. Most of the carbonated beverage 50 is liquid.

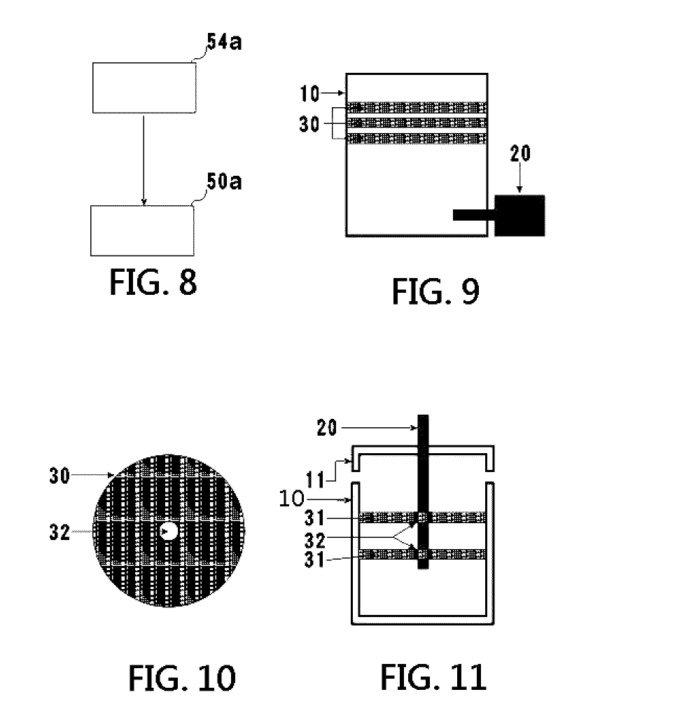

FIG. 8 schematically illustrates a process for making a carbonated beverage by the foam-inhibiting apparatus. Referring to FIG. 8, in a step 54a, a liquid is provided. In a step 50a, the liquid is carbonated, whereby the liquid is foamed to have bubbles during the carbonation. The foaming of the liquid may be inhibited by an inhibitor 30 (FIG. 7).

FIG. 9 schematically illustrates a sectional view of foam-inhibiting apparatus for making a carbonated beverage, wherein the apparatus comprises a plurality of inhibitors, according to a third preferred embodiment.

If a lot of high pressure carbon dioxide is poured into a liquid in a vessel 10, the pouring may generate power enough to make the liquid wave up and down, to move the liquid with a large vertical distance.

Referring to FIG. 9, preferably, a carbonator 20 is penetrated through the vessel 10. An inhibitor, preferably three metal meshes 31, may be positioned in the vessel 10. The metal meshes 31 may be located along the way which is being passed though by the bubbles 40 (FIG. 5).

FIG. 11 schematically illustrates a sectional view of foam-inhibiting apparatus for making a carbonated beverage, wherein the apparatus comprises a first through hole, according to a fourth preferred embodiment.

Referring to FIG. 11, the apparatus comprises a vessel. The vessel comprises has a cup 10 and a lid 11 on the cup 10.

FIG. 10 schematically illustrates a top view of an inhibitor 30. Referring to FIG. 11 and FIG. 10, the inhibitor 30 may be penetrated by a carbonator 20. The carbonator 20 penetrates from the top of the lid 11, through the metal meshes 31, and into the cup 10. The penetration prevents bubbles from being generated or leaving on the inhibitor 30. The carbonator 20 may alternatively be another type of supplier.

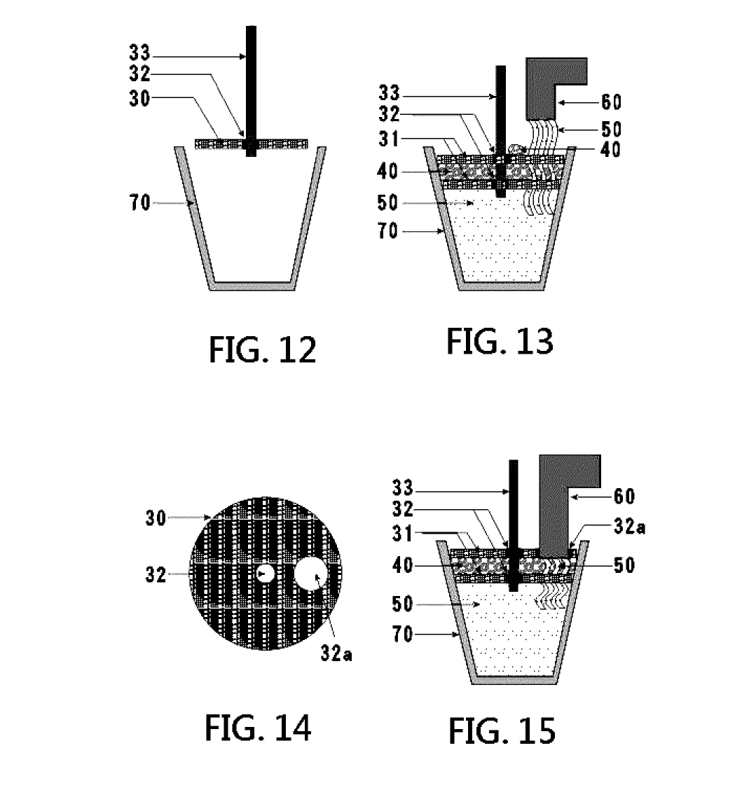

FIG. 12 schematically illustrates a sectional view of apparatus for making a carbonated beverage, wherein the apparatus comprises a grip, according to a fifth preferred embodiment. The apparatus may comprise an inhibitor 30.

FIG. 13 schematically illustrates a sectional view of applying the apparatus of FIG. 12. Referring to FIG. 13, an inhibitor may comprise an upper metal mesh 31a and a lower metal mesh 31b.

Referring FIG. 13, the apparatus may further comprise a grip 33 penetrating through the inhibitor. The grip is connected to the inhibitor 30 for lowering the inhibitor 30 into a cup 70 or for lifting the inhibitor out of the cup 70. The inhibitor has a first through hole 32. The inhibitor is penetrated by the grip 33 via the first through hole 32. The apparatus may further comprise a supplier 60 for supplying the carbonated liquid 50 into the cup 70.

Referring to FIG. 13, each of the upper metal mesh 31a and the lower metal mesh 31b may have the first through hole 32. After the supplier 60 supplies the carbonated beverage 50 into the cup 70, a few bubbles 40 leave between upper metal mesh 31a and the lower metal mesh 31b, or leave on the upper metal mesh 31a.

FIG. 15 schematically illustrates another sectional view of applying the apparatus of FIG. 12.

FIG. 14 schematically illustrates a top view of the upper metal mesh and the lower metal mesh of FIG. 15. Referring to FIG. 15 and FIG. 14, each of the upper metal mesh 31a and the lower metal mesh 31b may have the first through hole 32. The supplier 60 is through the upper metal mesh 31a. The upper metal mesh 31a may have a second through hole 32a. Via the second through hole 32a, the supplier 60 is through the upper metal mesh 31a.

Referring to FIG. 15, through the supplier 60, a carbonated beverage 50 is poured to the cup 70. Without the inhibitor 30 (FIG. 14), the force of pouring and the change of pressure may generate a lot of bubbles 40.

Referring to FIG. 15, after the supplier 60 supplies the carbonated beverage 50 into the cup 70, no bubble leaves on the upper metal mesh 31a.

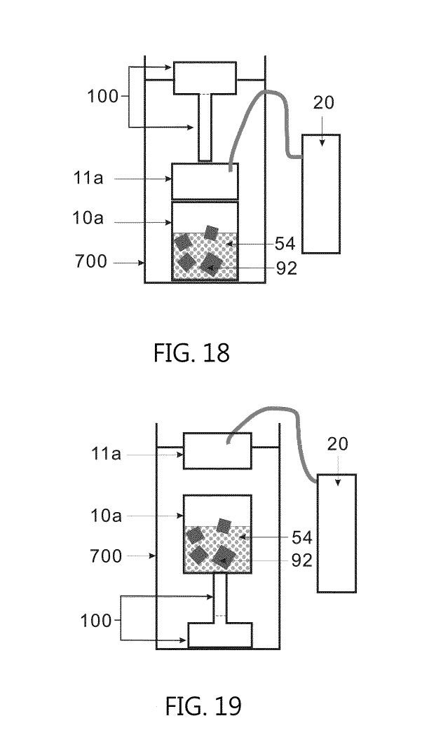

FIG. 18 schematically illustrates a sectional view of apparatus for making a carbonated beverage, according to a sixth preferred embodiment.

Referring to FIG. 18, the apparatus may comprise a carbonator 20 and an inhibitor 30 (FIG. 10 or FIG. 14). The carbonator 20 is for carbonating a liquid 54, wherein the liquid 54 is foamed to have a plurality of bubbles during the carbonation. The inhibitor 30 may be penetrated with the carbonator 20, as shown in FIG. 15, for example, for inhibiting the foaming of the liquid 54.

Referring to FIG. 18, the apparatus may further comprise a cup 10a and a lid 11a on the cup 10a. The cup 10a has the liquid 54 therein. The apparatus may further comprise a driver 100 to press the lid 11a on the cup 10a, thereby sealing them as a vessel. The apparatus may further comprise a casing 700 for positioning the cup 10a, the lid 11a and the driver 100.

FIG. 19 schematically illustrates a sectional view of apparatus for making a carbonated beverage, according to a seventh preferred embodiment.

Referring to FIG. 19, the apparatus may comprise a carbonator 20 and an inhibitor 30 (FIG. 10 or FIG. 14). The carbonator 20 is for carbonating a liquid 54, wherein the liquid 54 is foamed to have a plurality of bubbles during the carbonation. The inhibitor 30 may be penetrated with the carbonator 20, as shown in FIG. 15, for example, for inhibiting the foaming of the liquid 54.

Referring to FIG. 19, the apparatus may further comprise a cup 10a and a lid 11a on the cup 10a. The cup 10a has the liquid 54 therein. The apparatus may further comprise a driver 100 to lift the cup 10a, thereby sealing the cup 10a with the lid 11a as a vessel. The driver 100 may also be functioned to lower the cup 10a, thereby opening the vessel. The apparatus may further comprise a casing 700 for positioning the cup 10a, the lid 11a and the driver 100.

Obviously, many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. Apparatus for making a beverage, comprising:
a cup having a carbonated liquid therein, wherein the liquid is foamed; and
an inhibitor for inhibiting the foaming of the carbonated liquid.

2. The apparatus according to claim 1, wherein the inhibitor comprises an upper metal mesh and a lower metal mesh.

3. The apparatus according to claim 1, further comprising a grip penetrating through the inhibitor.

4. The apparatus according to claim 3, wherein the grip is connected to the inhibitor for lowering the inhibitor into the cup or for lifting the inhibitor out of the cup.

5. The apparatus according to claim 2, wherein the inhibitor has a first through hole.

6. The apparatus according to claim 5, wherein the inhibitor is penetrated by the grip via the first through hole.

7. The apparatus according to claim 6, further comprising a supplier for supplying the carbonated liquid into the cup.

8. The apparatus according to claim 7, wherein the supplier is through the upper metal mesh.

9. The apparatus according to claim 8, wherein the upper metal mesh has a second through hole.

10. The apparatus according to claim 9, wherein the supplier is through the upper metal mesh via the second through hole.

11. Apparatus for making a beverage, comprising:
a carbonator for carbonating a liquid, wherein the liquid is foamed to have a plurality of bubbles; and
an inhibitor, being penetrated with the carbonator, for inhibiting the foaming of the liquid.

12. The apparatus according to claim 11, wherein the inhibitor has a plurality of voids.

13. The apparatus according to claim 12, wherein the neighboring voids have a connector proper to inhibit the foaming of the liquid, and proper to break the bubbles.

14. The apparatus according to claim 11, further comprising a pressure vessel having the liquid therein, and wherein the pressure vessel has a cup and a lid on the cup.

15. The apparatus according to claim 14, further comprising a driver to seal the pressure vessel by pressing the lid on the cup.

16. The apparatus according to claim 14, further comprising a driver to seal the pressure vessel by lifting the cup.

17. The apparatus according to claim 16, further comprising a driver to open the pressure vessel by lowering the cup.

18. The apparatus according to claim 15, further comprising a casing for positioning the cup, the lid and the driver.

19. The apparatus according to claim 17, further comprising a casing for positioning the cup, the lid and the driver.

20. A method for making a beverage, comprising:
carbonating a liquid, wherein the liquid is foamed to have a plurality of bubbles; and
inhibiting the foaming of the liquid by a filter plate having a plurality of voids.
